(19) United States
(12) Patent Application Publication
(10) Pub. No.: US 2014/0154541 A1
(43) Pub. Date: Jun. 5, 2014

(54) ASSEMBLED BATTERY

(71) Applicants: Kazuma ASAKURA, Toyota-shi (JP); Kosuke KUSABA, Inazawa-shi (JP); Katsunori SATO, Toyota-shi (JP)

(72) Inventors: Kazuma ASAKURA, Toyota-shi (JP); Kosuke KUSABA, Inazawa-shi (JP); Katsunori SATO, Toyota-shi (JP)

(73) Assignee: TOYOTA JIDOSHA KABUSHIKI KAISHA, Toyota-shi (JP)

(21) Appl. No.: 14/085,890

(22) Filed: Nov. 21, 2013

(30) Foreign Application Priority Data
Nov. 30, 2012 (JP) 2012-263615

(51) Int. Cl. H01M 2/12

(52) U.S. Cl. CPC H01M 2/1252
USPC 429/82

(57) ABSTRACT

An assembled battery including a plurality of single batteries, a fin shaped portion and a sheet member is provided. The fin shaped portion is disposed outside of the plurality of the single batteries. A gas exhaustion path is defined between the fin shaped portion and the plurality of a plurality of the single batteries. A gas discharged from the single batteries from the assembled battery is discharged from the assembled battery to an outside of the assembled battery through the gas exhaustion path in a battery abnormal condition. The sheet member is disposed between the gas exhaustion path and the plurality of the single batteries, and is an insulating member.

### INCORPORATION BY REFERENCE

The disclosure of Japanese Patent Application No. 2012-263615 filed on Nov. 30, 2012 including the specification, drawings and abstract is incorporated herein by reference in its entirety.

### BACKGROUND OF THE INVENTION

1. Field of the Invention

The invention relates to an assembled battery having a plurality of single batteries.

2. Description of Related Art

Hybrid cars, electric cars and the like are equipped with electric charge apparatuses which charge activation electric powers supplied to motors for driving vehicles. As such an electric charge apparatus, Japanese Patent Application Publication No. 2012-109126 discloses an electric charge apparatus which is provided with a plurality of electric charge devices disposed to align in a predetermined direction, a pair of end plates with a plurality of the electric charge devices interposed therebetween, a plurality of connection members which extends in a predetermined direction and is fixed to a pair of the end plates, a case accommodating therein a plurality of the electric charge devices, in which at least two connection members disposed along an outer surface of the electric charge device provided with a valve come into contact with an inner surface of the case to form a transfer space for passing therethrough a gas discharged from the valve together with the case.

However, in the above configuration, the gas discharged from the valve may cause abnormal heating by heating other electric charge devices when passing through the transfer space. In addition, foreign materials contained in the transfer space may come into contact with an electrically conductive portion, and the electric charge devices may suffer from short circuit by condensation.

### SUMMARY OF THE INVENTION

The present invention has been accomplished in view of the above problems, and has an object to provide an assembled battery for preventing short circuit of a single battery resulting from contamination of foreign materials and the like as well as rapidly cooling a gas discharged from the single battery.

According to one aspect of the invention in the present application, an assembled battery having a plurality of single batteries and a gas exhaustion path is provided. The gas exhaustion path is configured to exhaust such that a gas discharged from the single battery is discharged from the assembled battery to an outside of the assembled battery through the gas exhaustion path in case of battery abnormal condition. In addition, the gas exhaustion path is provided at its inner surface with a fin shaped portion. Besides, a sheet member is disposed between the gas exhaustion path and the plurality of the single batteries, and the sheet member is an insulating member.

According to the above single battery, it is possible to prevent short circuit of the single battery resulting from contamination of foreign materials and the like, and rapidly cool the gas discharged from the single battery.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 shows an exploded perspective view of an assembled battery according to an embodiment of the present invention;

FIG. 2 shows an external perspective view of the assembled battery shown in FIG. 1;

FIG. 3 shows a cross-sectional view of a single battery shown in FIG. 1;

FIG. 4 shows an X-Z cross-sectional view of the assembled battery;

FIG. 5 shows an expanded view of a portion of the assembled battery shown in FIG. 4;

FIG. 6 shows a schematic view corresponding to FIG. 5, in which an electrically conductive foreign material is schematically shown;

FIG. 7 shows a schematic view corresponding to FIG. 5, in which an electrically conductive foreign material and gas are schematically shown;

FIG. 8 shows a schematic plan view of the assembled battery;

FIG. 9 shows a modified example 1 of a fin shaped portion corresponding to FIG. 5; and

FIG. 10 shows another modified example 1 of a fin shaped portion corresponding to FIG. 5

### DETAILED DESCRIPTION OF EMBODIMENTS

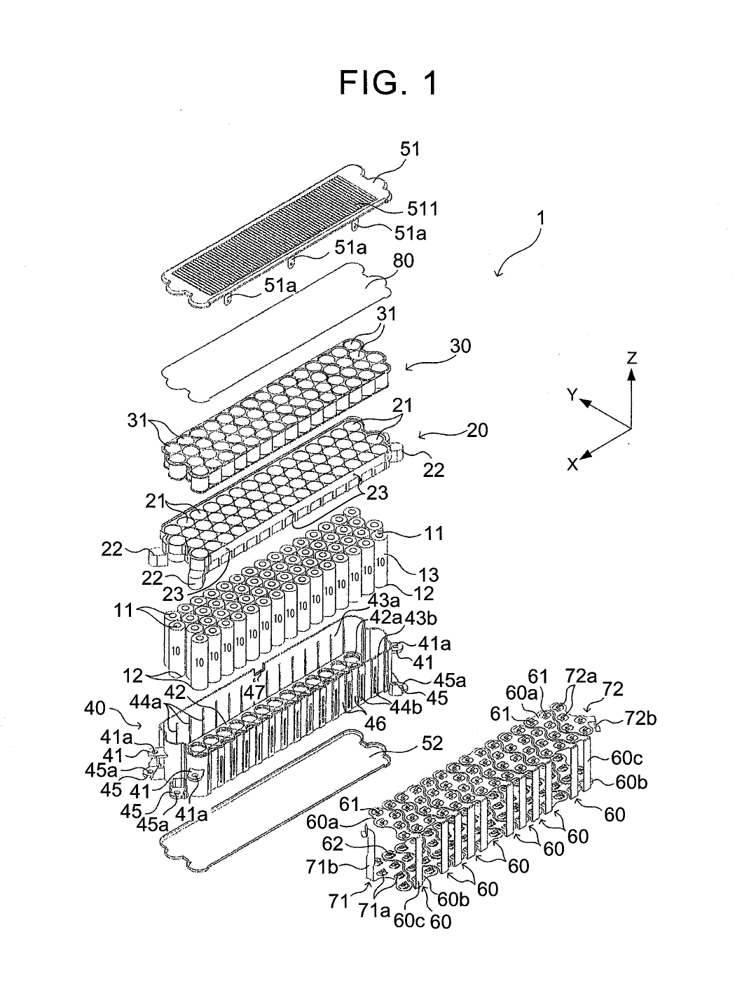

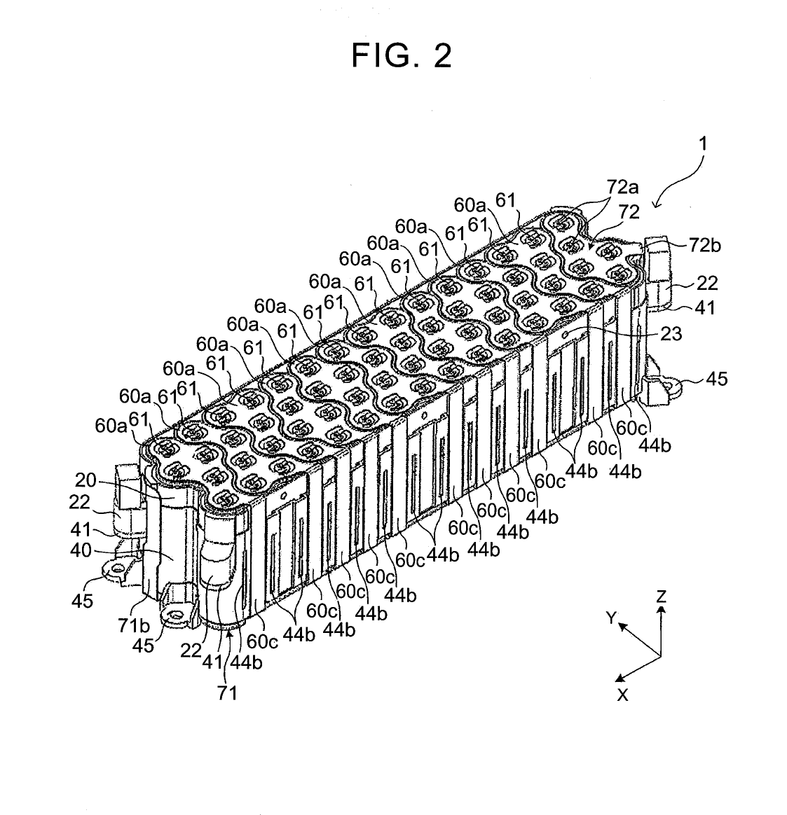

Explanations are given with reference to figures, as to an assembled battery in an embodiment of the present invention. FIG. 1 shows an exploded perspective view of the assembled battery. FIG. 2 shows an external perspective view of the assembled battery. X-axis, Y-axis and Z-axis are three axes orthogonally crossed with each other. In explanations given below, X-axis is referred to as +X-axis, the opposite direction of X-axis is referred to as −X-axis, Y-axis is referred to as +Y-axis, the opposite direction of Y-axis is referred to as −Y-axis, Z-axis is referred to as +Z-axis, the opposite direction of Z-axis is referred to as −Z-axis. But, in case differentiation between +X-axis and −X-axis is not necessary, these axes are expressed as X-axis. In case differentiation between +Y-axis and −Y-axis is not necessary, these axes are expressed as Y-axis. In case differentiation between +Z-axis and −Z-axis is not necessary, these axes are expressed as Z-axis.

The assembled battery 1 has a plurality of single batteries 10. The single battery 10 is a so-called tubular battery, in which a battery case formed into tubular shape accommodates elements of energy power generation therein. The single battery 10 may be formed of a secondary battery such as nickel hydrogen battery and lithium battery. In addition, an electric double-layer capacitor may be used instead of the secondary battery.

All of the single batteries 10 forming the assembled battery 1 are disposed in such a manner that a positive terminal 11 and a negative terminal 12 are located upwards and downwards, respectively, as shown in FIG. 1. That is, all of the positive electrode terminals 11 of the single battery 10 are disposed so as to align within a single plane (X-Y plane). In other words, all of the negative electrode terminals 12 of the single battery 10 are disposed so as to align within a single plane (X-Y plane). Detailed explanations of the single battery 10 are given below.

Each of the single battery 10 is supported by a holder 20. The holder 20 has opening portions 21 for receiving therein each single battery 10. The opening portion 21 is formed into outer peripheral shape (specifically, circular shape) of the single battery 10. The number of the opening portions is the same as that of the single batteries 10.

But, the number of the opening portions 21 of the holder 20 is not limited to the number of the single batteries 10. For example, in case of supporting a battery group formed of a plurality of the single batteries 10 connected in series in an axis direction, the battery group can be supported with a single opening portion 21. In addition, some of the opening portions 21 may serve as opening portions not supporting the single battery 10, in which the opening portion may serve as a space for passing therethrough a busbar (an electrically conductive member). In addition, the opening portions supporting single batteries 10 adjacent to each other in radius direction may be connected together with each other to form a single opening portion 21.

When the holder 20 is formed of a greatly thermally conductive material such as aluminum, it is possible to easily transmit heat generated in the single batteries 10 resulting from charging and discharging to the holder 20. It is possible to suppress temperature unevenness of each of the single batteries 10 by dissipating heat of the single battery 10 towards the holder 20.

An insulating body 30 is disposed between the opening portion 21 of the holder 20 and the single battery 10. The insulating body 30 is formed of an insulating material such as resin, for example, so as to achieve insulating condition between the single battery 10 and the holder 20. The insulating body 30 is formed with an opening portion 31 for receiving therein the single battery 10. The number of the opening portions 31 is the same as that of the single batteries 10.

The insulating body 30 is formed of an elastically deformable material (for example, a resin used in mold injection), or an adhesion agent formed of a thermosetting resin. When the insulating body 30 is elastically transformed and a resin is filled into a space between the single battery 10 and the holder 20, it is possible to keep the outer peripheral surface of the single battery 10 and the opening portion 21 of the holder 20 securely into contact with the insulating body 30. As such, elastically transforming the insulating body 30 and adhering the insulating body 30 to the holder 20 make it possible to fix each single battery 10 to the holder 20. For example, each single battery 10 can be inserted into the opening portion 21 of the holder 20, and then a material forming the insulating body 30 can be filled into the space between the single battery 10 and the opening portion 21 for the formation of the insulating body 30.

The holder 20 is fixed to a module case 40. The module case 40 is formed at its top surface with an opening portion for receiving therein a plurality of the single batteries 10. The top surface of the module case 40 is closed with the holder 20. The holder 20 is provided at its outer peripheral edge with a plurality of flanges 22. The number of flanges 22 can be set as appropriate. The module case 40 is provided with a plurality of flanges 41 for supporting the flanges 22. Each of the flanges 41 is provided at a portion corresponding to each flange 22 of the holder 20.

The flange 22 is attached to the flange 41, making it possible to position the holder 20 in relation to the module case 40. Specifically, a portion of the flange 22 comes into contact with an outer wall surface of the module case 40, making it possible to position the holder 20 in relation to the module case 40 within X-Y plane.

Each of the flanges 41 is formed with a hole portion 41a for receiving a bolt (not shown) thereinto. In addition, the flange 22 is formed with a screw groove (not shown) for receiving a bolt therein. The bolt is inserted into the hole portion 41a and the screw groove of the flange 22, making it possible to fix the holder 20 to the module case 40. That is, the holder 20 can be prevented from moving in X-axis direction in relation to the module case 40.

The module case 40 surrounds a plurality of the single batteries 10 within X-Y plane, and accommodates a plurality of the single batteries 10 therein. The module case 40 is formed at its bottom surface 42 with a plurality of opening portions 42a. The number of the opening portions 42a is the same as that of the single batteries 10. The single battery 10 is inserted into the opening portion 42a, making it possible to position each single battery 10 in relation to the module case 40.

That is, the region of the negative electrode terminal 12 side of the single battery 10 is positioned within X-Y plane by an opening portion 42a of the module case 40. Meanwhile, the region of the positive electrode terminal 11 side of the single battery 10 is positioned within X-Y plane by an opening portion 21 of the holder 20. In this embodiment, the single battery 10 is positioned at its opposite ends in its longitudinal direction (Z-axis direction) by the module case 40 and the holder 20, so as to prevent two adjacent single batteries 10 from coming into contact with each other in X-Y plane.

The module case 40 may be formed of an insulating material such as resin. With this arrangement, it is possible to achieve insulating condition between two single batteries 10 adjacent to each other in X-Y plane. When the single battery 10 can be covered at its outer surface with a layer formed of an insulating material, it is possible to achieve insulating condition between two single batteries 10 adjacent to each other within X-Y plane, Meanwhile, the module case 40 may be formed of an electrically conductive material. In such a case, the module case 40 may be formed at its surface facing the single battery 10, with a layer formed of an insulating material for achieving insulating condition between the module case 40 and the single battery 10.

The module case 40 has lateral walls 43a, 43b which face each other in Y-axis direction. The lateral wall 43a is formed with a plurality of slits 44a which are disposed to align in X-axis direction. Each of the slits 44a extends in Z-axis direction, and is formed with a rectangular shaped opening.

The slit 44a is utilized for taking a heat exchanging medium for controlling temperature of the single battery 10 within the interior of the module case 40, as described below. Specifically, a. chamber (not shown) extending in X-axis direction can be attached to the lateral wall 43a, and provided with the heat exchanging medium, so as to allow the heat exchanging medium provided in the chamber to pass through the slit 44a and then transfer to the interior of the module case 40.

The module case 40 is formed at its lateral wall 43a with a plurality of slits 44b disposed to align in X-axis direction. Each of the slits 44b extends in Z-axis direction, and formed with a rectangular-shaped opening. The slit 44b is utilized for exhausting the heat exchanging medium located in the interior of the module case 40 outwardly from the module case 40, as described below. Specifically, when the chamber (not shown) extending in X-axis direction is attached to the lateral wall 43b, it is possible to allow the heat exchanging medium passing through the slit 44b to the chamber for the purpose of exhausting the heat exchanging medium from the chamber.

In case the single battery 10 is heated by charging or discharging, it is possible to suppress the rise in temperature of the single battery 10 by supplying the heat exchanging medium for cooling to the interior of the module case 40. Namely, it is possible to transmit the heat of the single battery 10 to the heat exchanging medium by heat exchange between the heat exchanging medium and the single battery 10, for the purpose of suppressing the rise in temperature of the single battery 10. The heat exchanging medium may be air or the like. In order to cool the single battery 10, a precooled heat exchanging medium may be used for achieving a lower temperature than that of the single battery 10.

Meanwhile, the heat exchanging medium for heating can be provided in the interior of the module case 40 for suppressing the reduction in temperature of the single battery 10 when the single battery 10 is excessively cooled due to external environment. Namely, it is possible to transmit the heat of the heat exchanging medium to the single battery 10 by heat exchanging between the heat exchanging medium and the single battery 10 for the purpose of suppressing the reduction in temperature of the single battery 10. The heat exchanging medium may be air or the like. In order to warm the single battery 10, a prewarmed heat exchanging medium such as a heater can be used for achieving a higher temperature than that of the single battery 10.

The module case 40 is formed at an end portion in +Y-axis direction with a gas exhaustion opening 47. The gas exhaustion opening 47 is formed at a substantially intermediate portion of +Z-axis directional terminal of the lateral wall 43a in X-axis direction. The gas exhaustion opening 47 may be connected with a gas exhaustion duct not shown in figures. It is possible to exhaust the gas discharged from the single battery 10 outwardly from the assembled battery 1 through the gas exhaustion duct. The assembled battery 1 is formed at its interior with a gas exhaustion path connected to the gas exhaustion opening 47. Detailed explanations are given below as to the gas exhaustion path.

The module case 40 is provided at its lower portion with a plurality of brackets 45. The bracket 45 has an opening portion 45a for receiving therethrough a bolt (not shown). When being mounted to a specific apparatus, the assembled battery 1 in this embodiment is provided with the bracket 45. Namely, with the use of the bolt inserted into the bracket 45, it is possible to mount the assembled battery 1 to a specific apparatus. For example, the assembled battery 1 can be mounted to a vehicle. In such a case, the assembled battery 1 is fixed to a vehicle body with use of the bracket 45.

When the assembled battery 1 is mounted to a vehicle, it is possible to convert an electric energy output from the assembled battery 1 into a kinetic energy with use of a motor generator. The kinetic energy can be transmitted to wheels for operating the vehicle. In addition, with the use of the motor generator, it is possible to convert the kinetic energy generated by vehicle operation into an electric energy. The electric energy can be stored in the assembled battery 1 as regenerative electric power.

The holder 20 is formed at its top surface with a positive electrode cover 51. The positive electrode cover 51 is not shown in FIG. 2. The positive electrode cover 51 has arm portions 51 a extending along Z-axis direction. The arm portion 51 a is formed at its front end with an opening. The holder 20 is provided at its outer periphery with pins 23. The pins 23 are inserted into the opening portions of the arm portions 51a. With this arrangement, it is possible to fix the positive electrode cover 51 to the holder 20.

The positive electrode cover 51 is formed with a fin shaped portion 511 which is described below in detail. A space is formed between the positive electrode cover 51 and the holder 20. The space is divided by an insulating sheet 80 into an accommodation portion for accommodating therein a first region 60a of a busbar 60 described below, and a gas exhaustion path for transferring gas exhausted from the single battery 10.

In this embodiment, as described above, all of the positive electrode terminals 11 of the single batteries 10 are positioned upwards of the assembled battery 1. With this arrangement, it is possible to store the gas exhausted from each positive electrode terminal 11 into a single space formed between the positive electrode cover 51 and the holder 20.

In case the positive electrode terminals 11 of a plurality of the single batteries 10 are disposed on both of top surface and bottom surface of the assembled battery 1, the gas is exhausted from top surface and bottom surface of the assembled battery 1. In such a case, it is necessary to provide an exhaustion path of gas (gas exhaustion path) to each of the top surface and the bottom surface of the assembled battery 1, causing the gas exhaustion path to get enlarged. In this embodiment, it is possible to suppress the growth in size of the gas exhaustion path solely by providing the gas exhaustion path only to the top surface of the assembled battery 1.

In addition, the gas exhausted from the single battery 10 can be easily moved upwards. As such, it is possible to easily exhaust the gas from the positive electrode terminal 11 when the single battery 10 is disposed such that the positive electrode terminal 11 is directed upward.

The module case 40 is closed at its bottom surface 42 with a negative electrode cover 52. The negative electrode cover 52 is formed into a shape along a bottom surface 42 of the module case 40. Busbars 60, 71 described below axe disposed between the negative electrode cover 52 and the bottom surface 42. The negative electrode cover 52 is utilized for protecting the busbars 60, 71.

The positive electrode tub 61 of the busbar 60 is connected to the positive terminal 11 of the single battery 10 protruding from the holder 20 (insulating body 30). The positive electrode tub 61 is provided at a portion which faces the positive electrode terminal 11 in Z-axis direction. The positive electrode terminal 11 and the positive electrode tub 61 are connected by welding. In this embodiment, five positive electrode tubs 61 are formed in a first region 60a of the busbar 60. The first region 60a is formed into a plate-like extending along X-Y plane. The first region 60a of the busbar 60 is disposed between the holder 20 and the positive electrode cover 51 as described above.

The number (one or more) of the positive electrode tubs 61 formed in the first region 60a can be selected, as appropriate. As described below, when a plurality of the single batteries 10 are electrically connected in parallel, the number of positive electrode tubs 61 formed in the first region 60a can be selected according to the number of the single batteries 10 electrically connected in parallel. In other words, the number of positive tubs 61 formed in the first region 60a is the number of the single batteries 10 electrically connected in parallel. In this embodiment, each of the first regions 60a of a plurality of the busbars 60 is formed into a shape according to the position of the corresponding positive electrode tub 61.

The negative electrode tub 62 of the busbar 60 is connected to the negative electrode terminal 12 of the single battery 10 protruding through the opening portion 42a of the module case 40. The negative electrode tub 62 is formed at a portion which faces the negative electrode terminal 12 in Z-axis direction. The negative electrode terminal 12 and the negative electrode tub 62 are connected by welding. In this embodiment, five negative electrode tubs 62 are formed in the second region 60b of the busbar 60. The second region 60b is formed into a plate-like shape extending along X-Y plane. The second region 60b of the busbar 60 is disposed between the module case 40 and the negative electrode cover 52 as described above.

The number (one or more) of the negative tubs 62 formed in the second regions 60b can be selected, as appropriate. As described below, when a plurality of the single batteries 10 are electrically connected in parallel, the number of negative electrode tubs 62 formed in the second regions 60b can be selected according to the number of the single batteries 10 electrically connected in parallel. In other words, the number of negative tubs 62 formed in the second regions 60b is the number of the single batteries 10 electrically connected in parallel. In this embodiment, each of the second regions 60b of a plurality of the busbars 60 is formed into a shape according to the position of the corresponding negative electrode tub 62.

The first region 60a and the second region 60b are connected to each other via a third region 60c extending along Z-axis direction. In other words, the third region 60c is connected at its top end to the first region 60a, and connected at its bottom end to the second region 60b. The third region 60c is disposed outside of the module case 40. All of the third regions 60c of the busbar 60 are disposed to align in X-axis direction, and disposed along the lateral wall 43b of the module case 40.

The lateral wall 43b is formed at its outer surface with a concave portion 46, which accommodates the third region 60c. The concave portion 46 is formed between two slits 44b adjacent to each other in X-axis direction. The third region 60c of the busbar 60 is positioned between two slits 44b adjacent to each other in X-axis direction.

The assembled battery 1 in this embodiment is provided with busbars 71, 72 besides the busbar 60. The busbars 71, 72 are provided at opposite edges of the assembled battery 1 in X-axis direction, and has a different shape from the busbar 60.

The busbars 71 is provided with a negative electrode tub 71a connected to the negative electrode terminal 12, and not connected to the positive terminal 11. In this embodiment, the busbar 71 is connected to five negative electrode terminals 12, and thereby provided with five negative electrode tubs 71a. The busbar 72 is provided with a positive electrode tub 72a connected to the positive electrode terminal 11, and not connected to the negative electrode terminal 12. In this embodiment, busbar 72 is connected to five positive electrode terminals 11, and thereby provided with five positive electrode tubs 72a.

A lead 71b provided to the busbar 71 is used as the negative electrode terminal of the assembled battery 1. A lead 72b provided to the busbar 72 is used as the positive electrode terminal of the assembled battery 1. When the assembled battery 1 is electrically connected to a load, the leads 71b, 72b are connected to the load via wire.

When a plurality of the assembled batteries 1 are electrically connected to each other in series, the lead 71b of one assembled battery 1 is electrically connected to the lead 72b of the other assembled battery 1. Herein, when a plurality of the assembled batteries 1 shown in FIG. 2 are aligned in X-axis direction, the lead 71b of one assembled battery 1 is disposed at a portion adjacent to the lead 72b of the other assembled battery 1, making it possible to easily connect the leads 71b,72b.

In this embodiment, a plurality of positive electrode tubs 61 formed in the first region 60a of the busbar 60 are connected to a plurality of the positive electrode terminals 11, and a plurality of the negative electrode tubs 62 formed in the second region 60b of the busbar 60 are connected to a plurality of the negative electrode terminals 12. With this arrangement, it is possible to electrically connect a plurality of the single batteries 10 with each other in parallel. Specifically, it is possible to electrically connect five single batteries 10 with each other in parallel. Herein, five single batteries 10 electrically connected in parallel form one battery block.

In this embodiment, with regard to one busbar 60, the positive electrode tub 61 in the first region 60a and the negative electrode tub 62 in the second region 60b are connected to different single batteries 10. Thereby, it is possible to electrically connect a plurality of the battery blocks via the third region 60c of the busbar 60 in series. In other words, it is possible to alter the number of the battery blocks electrically connected in series by altering the number of the busbar 60.

Meanwhile, in the battery block located in one end of the assembled battery 1, negative electrode terminals 12 of a plurality of the single batteries 10 are electrically connected to each other via the busbar 71 in parallel. Besides, in the battery block located in the other end of the assembled battery 1, the positive electrode terminals 11 of a plurality of the single batteries 10 are electrically connected to each other via the busbar 72 in parallel.

It is possible to set the number of the single batteries 10 forming the battery block, namely, the number of the single batteries 10 which are electrically connected to each other in parallel, as appropriate. It is possible to alter the number of the single batteries 10 electrically connected in parallel by altering the number of positive electrode tubs 61 formed in the first region 60a of the busbar 60 and the number of negative electrode tubs 62 formed in the second region 60b of the busbar 60. In case the number of the positive electrode tubs 61 is altered, the shape of the first region 60a is different from that of the first region 60a shown in FIG. 1 and FIG. 2. As well, in case the number of the negative electrode tubs 62 is altered, the shape of the second region 60b is different from that of the second region 60b shown in FIG. 1.

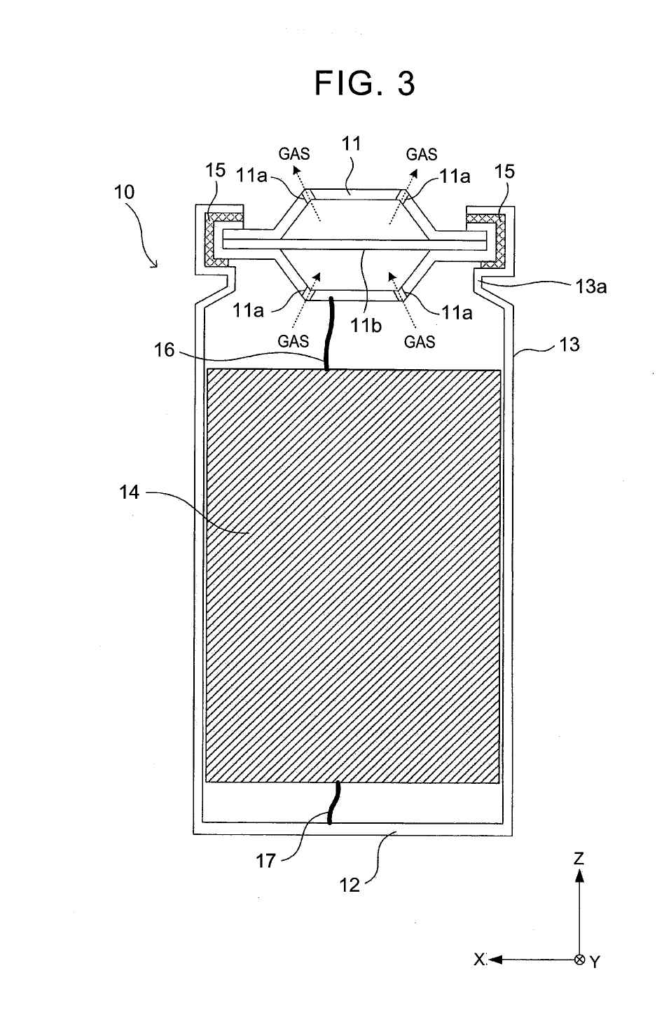

Next, detailed explanations are given as to configuration of the single battery 10 with reference to FIG. 3. FIG. 3 shows an X-Z cross-sectional view of the single battery. The single battery 10 includes a positive electrode terminal 11, a battery case 13 and an energy generation element 14. The battery case 13 formed into a tube having a bottom, which is formed at its inner peripheral surface with a protruding portion 13a protruding towards the interior in radial direction. The positive electrode terminal 11 is supported by the protruding portion 13a via a gasket 15 formed of an insulating material. The gasket 15 is formed of the insulating material, thereby it is possible to electrically insulate the positive electrode terminal 11 from the battery case 13. The battery case 13 is formed at its end portion in −Z direction with the negative electrode terminal 12 having the same electric potential as the battery case 13. The battery case 13 accommodates electric generation elements 14 therein. The electric generation elements 14 are connected to the positive electrode terminal 11 via a positive electrode lead 16, and connected to the negative electrode terminal 12 via a negative electrode lead 17.

The positive electrode terminal 11 is formed with a gas path 11a serving as a gas exhaustion valve and valve plate 11b. When an electrolyte is electrolytically decomposed to generate gas in case of battery abnormal condition resulting from excessive charge and excessive discharge, the generated gas increases internal pressure of the battery case 13. When the gas is further generated to increase the internal pressure of the battery case 13 up to the working pressure of the valve plate 11b, the valve plate 11b is broken so as to exhaust the gas outwardly from the single battery 10 through the gas path 11a. Spring type valve which opens under a predetermined pressure may be used instead of the valve plate 11b.

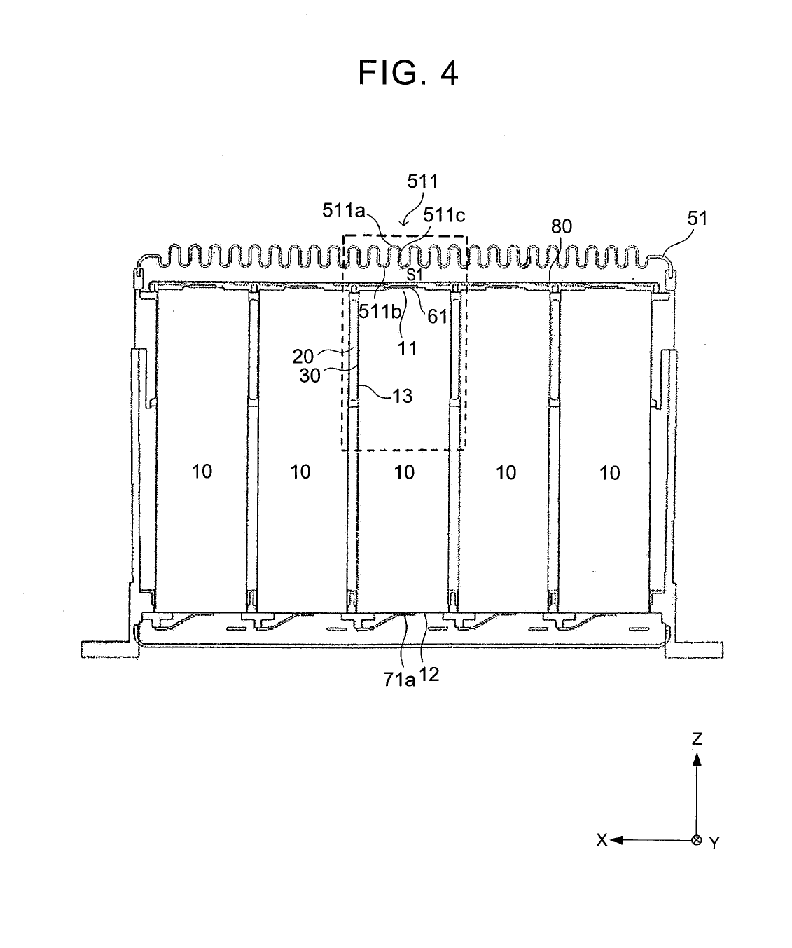

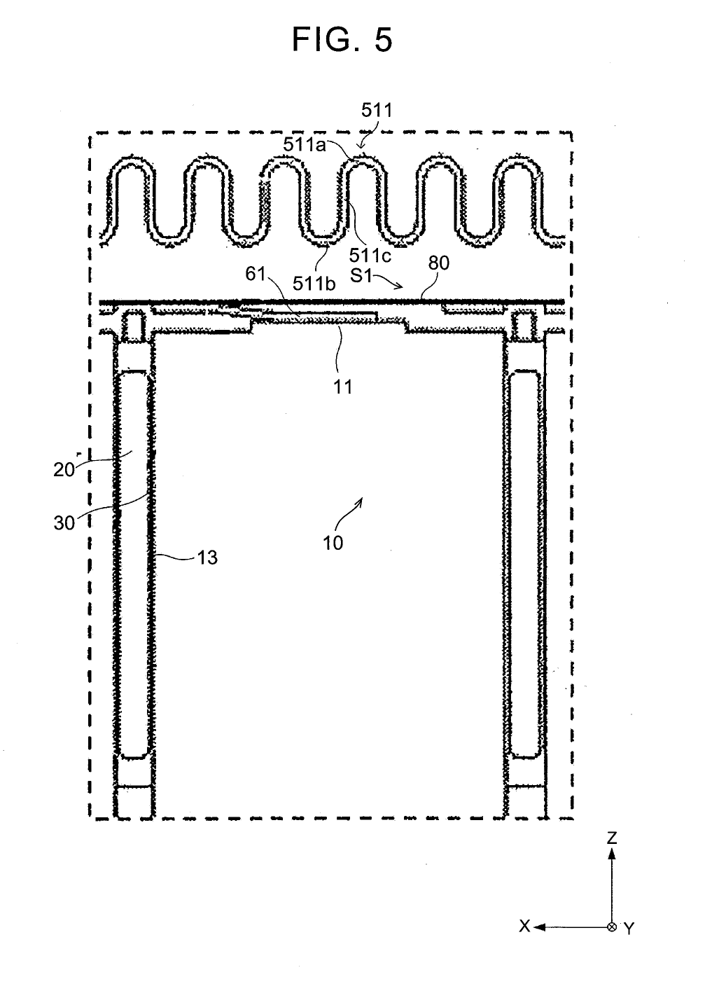

FIG. 4 shows a schematic X-Z cross-sectional view of the assemble battery. FIG. 5 shows an expanded view of expanded region surrounded by dot line in FIG. 4. With reference to these figures, the fin shaped portion 511 is formed at a region facing a plurality of the single batteries 10 in Z-axis direction. The fin shaped portion 511 is composed of a first curve shaped portion 511 a having a convex in +Z direction (that is, a direction away from the single battery 10), a second curve shaped portion 511b having a convex portion in −Z direction (that is, a direction close to the single battery 10) and a flat shaped portion 511c having a flat surface which extends in Z-axis direction and connects the first curve shaped portion 511a and the second curve shaped portion 511b, which are consecutively formed in X-axis direction.

Namely, the fin shaped portion 511 is composed of a concave portion formed of the first curve shaped portion 511a and a pair of the flat form portions 511c which face each other in X-axis direction, and a convex portion formed of the second curve shaped portion 511b and a pair of the flat form portions 511c, which are alternately consecutively formed in X-axis direction.

The insulating sheet 80 is adhered to the positive electrode tub 61, and a gas exhaustion path S1 is formed by a space between the insulating sheet 80 and the fin shaped portion 511. The interior of the module case 40 is divided by the insulating sheet 80 into an accommodation portion accommodating therein the first region 60a of the busbar 60 and a gas exhaustion path S1. The insulating sheet 80 is not required to be entirely formed of an insulating material, and may be formed of an insulating layer in an external portion. Therefore, the insulating sheet 80 may be formed by covering a peripheral portion of an electrically conductive member with the insulating material, for example.

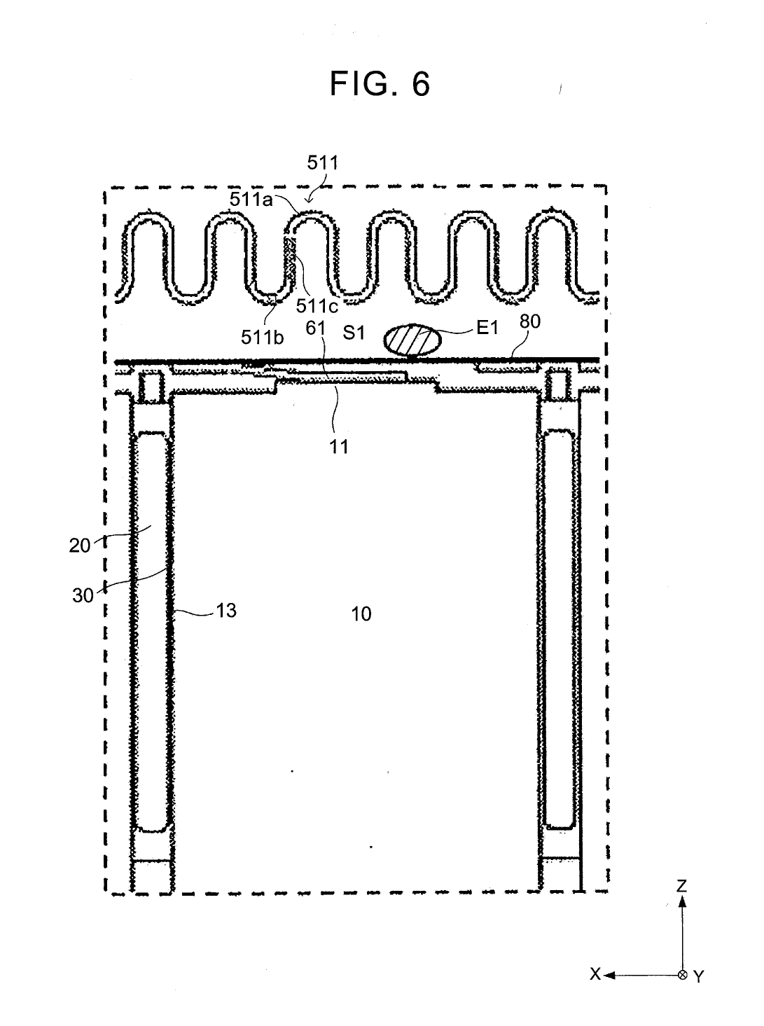

Next, explanations are given as to advantageous effects of the insulating sheet 80 with reference to FIG. 6. FIG. 6 corresponds to FIG. 5, and schematically shows a metallic foreign material E1 contained in the gas exhaustion path S1 by hatching. As shown in FIG. 3, the positive electrode terminal 11 is located close to the battery case 13 of the single battery 10. As such, in a configuration without the insulating sheet 80, the metallic foreign material E1 contained in the gas exhaustion path S1 may come into contact with both of the positive electrode terminal 11 and the battery case 13, causing short circuit of the single battery 10. Besides, in case of forming condensation in the gas exhaustion path S1, the single battery 10 may suffer from short circuit resulting from electrical conduction between the positive electrode terminal 11 and the battery case 13. Meanwhile, in this embodiment, as the gas exhaustion path S1 is separated from the accommodation portion accommodating the busbar 60 with the insulating sheet 80 adhered to the busbar 60, it is possible to prevent short circuit of the single battery 10 resulting from the metallic foreign material E1 contained in the gas exhaustion path S1 or condensed water.

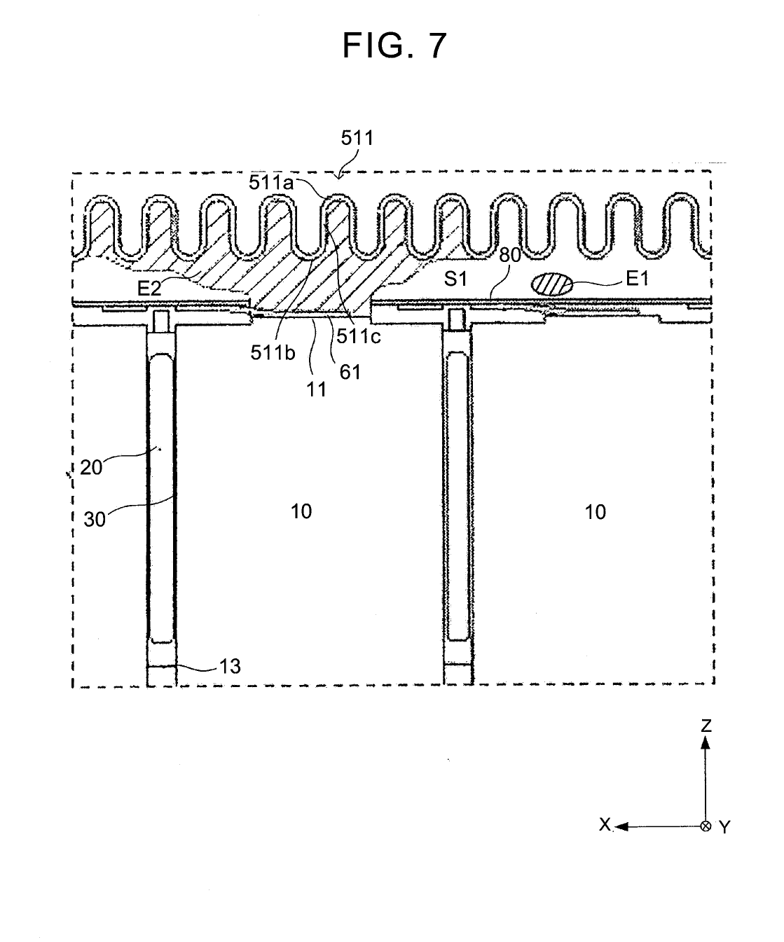

Next, explanations are given as to advantageous effects of combination of the insulating sheet 80 and the fin shaped portion 511 with reference to FIG. 7. FIG. 7 corresponds to FIG. 5, in which E1 and E2 shown by hatching schematically show a metallic foreign material and a gas which are exhausted from the single battery 10 into the gas exhaustion path S1, respectively.

As described above, the gas E2 is exhausted through the gas path 11a of the positive electrode terminal 11 in battery abnormal condition. As the gas E2 has a high temperature, the insulating sheet 80 is molten in the vicinity of the gas path 11a so as to be formed with an opening, allowing the gas E2 to be exhausted into the interior of the gas exhaustion path S1. Herein, the interior surface of the fin shaped portion 511 is formed of the concave portions and the convex portions which are consecutively aligned, and thereby has a large area for heat receiving. Thereby, it is possible to rapidly cool the gas E2 contained in the space interposed by a pair of the flat shaped portions 511c facing each other in X-axis direction. The exterior surface of the fin shaped portion 511 is also formed of the concave portions and the convex portions which are consecutively aligned, and has a large area for heat discharging. Thereby, it is possible to rapidly discharge the heat transmitted by the gas E2. Accordingly, it is possible to suppress the heating of the single battery 10 which is not in the battery abnormal condition caused by the gas E2.

Besides, it is possible to reduce the area of the insulating sheet 80 to be molten by the gas E2. Namely, the insulating sheet 80 is molten only in the region corresponding to single batteries 10 in the battery abnormal condition, and not molten in the region corresponding to single batteries 10 not in the battery abnormal condition. Thereby, it is possible to keep insulating performance of the single batteries 10 even in the battery abnormal condition. Namely, it is possible to prevent short circuit of the batteries resulting from the electrical conduction between the positive electrode terminal 11 and the negative electrode terminal 12 of the single battery 10 caused by the metallic foreign material El discharged together with the gas E2.

Herein, the gas E2 discharged in the gas exhaustion path S1 causes to increase the internal pressure of the gas exhaustion path S1, increasing a load on the positive electrode cover 51. In this embodiment, the positive cover 51 is formed with the fin shaped portion 511 for increasing rigidity. Thereby, it is possible to sufficiently suppress deformation of the positive electrode cover 51 resulting from the increase in the internal pressure.

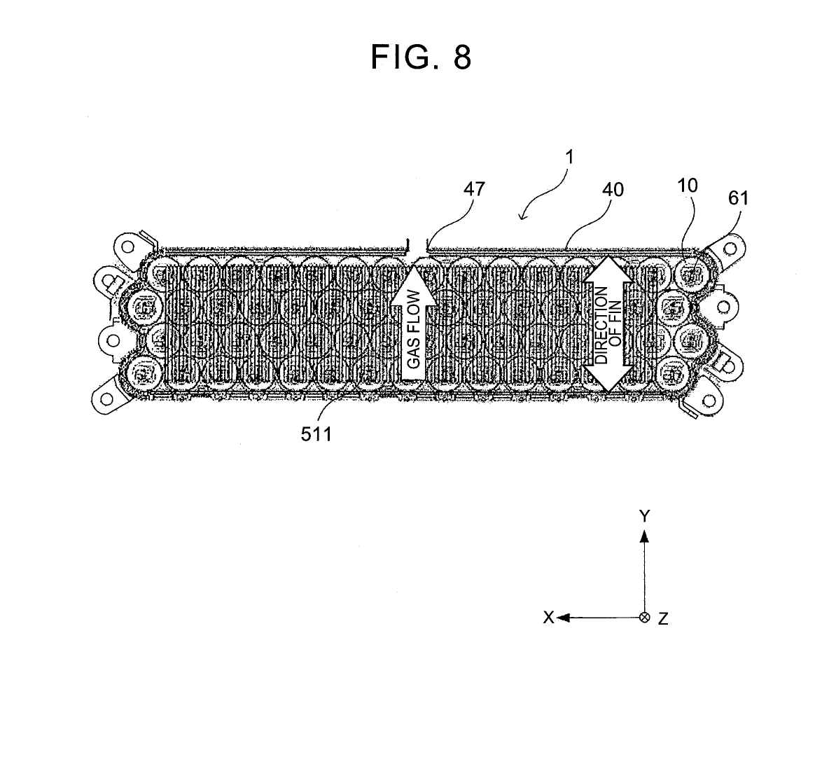

FIG. 8 shows a schematic plan view of the assembled battery, in which the insulating sheet 80 is not shown. As shown in FIG. 8, the fin shaped portion 511 extends in Y-axis direction and the gas exhaustion opening 47 is formed at a portion which corresponds to the end of fin shaped portion 511 in +Y-axis direction. Thereby, it is possible to suppress the prevention of the gas E2 from flowing through the gas exhaustion path S1 by the fin shaped portion 511. Namely, the space interposed the flat shaped portions 511c which face each other in X-axis direction extends in Y-axis direction, a gas exhaustion direction of the gas E2. Thereby, it is possible to reduce resistance of the gas E2 flowing towards the gas exhaustion opening 47 for rapidly exhausting the gas E2 outwardly from the assembled battery 1.

As described above, the fin shaped portion 511 in this embodiment has functions for prompting heat receiving, heat discharging and rapid exhaustion of the gas E2 as well as pressure resistance function, making it possible to achieve simplification of the structure by aggregation of function as well as reduced cost.

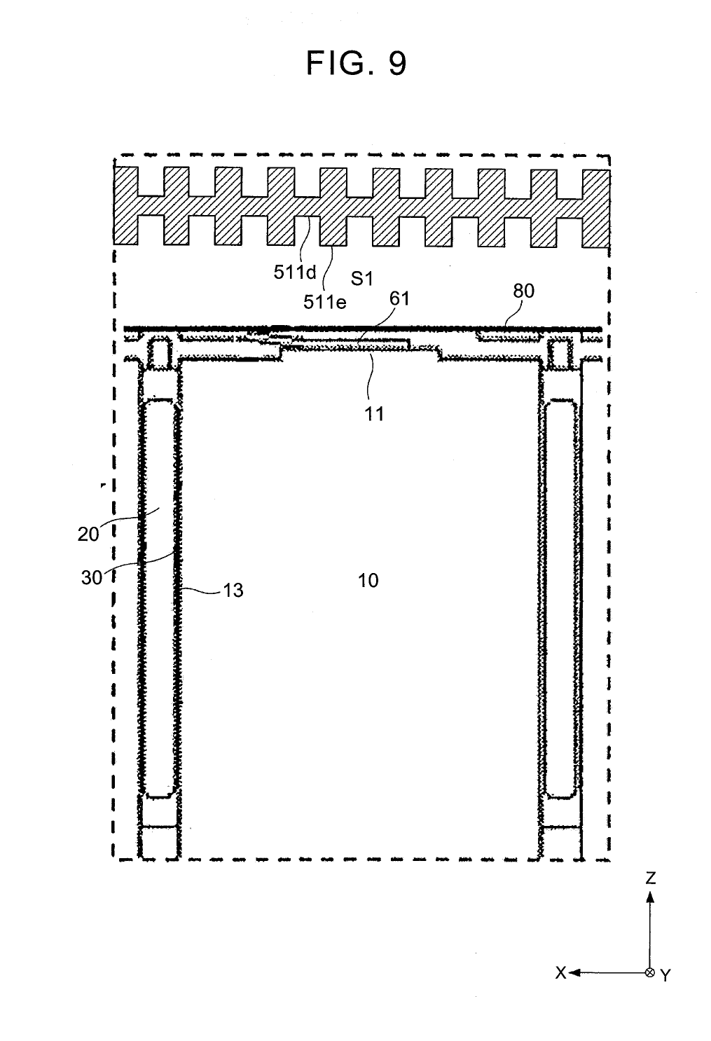

Next, explanations are given as to a modified example 1 of the fin shaped portion. In the above embodiment, the fin shaped portion 511 is configured by consecutively forming the first curve shaped portion 511a, the second curve shaped portion 511b and the flat form portion 511c in X-axis direction. The present invention is not limited to the configuration, and other forms may be used for prompting heat receiving and heat discharging. As a shape of the fin shaped portion in a modified example 1, for example, the first curve shaped portion 511a and the second curve shaped portion 511b may be modified into flat shaped portions 511d, 511e extending in X-axis direction for forming a concave convex form of the fin shaped portion 511, as shown in FIG. 9. As another shape of the fin shaped portion in the modified example 1, for example, so-called

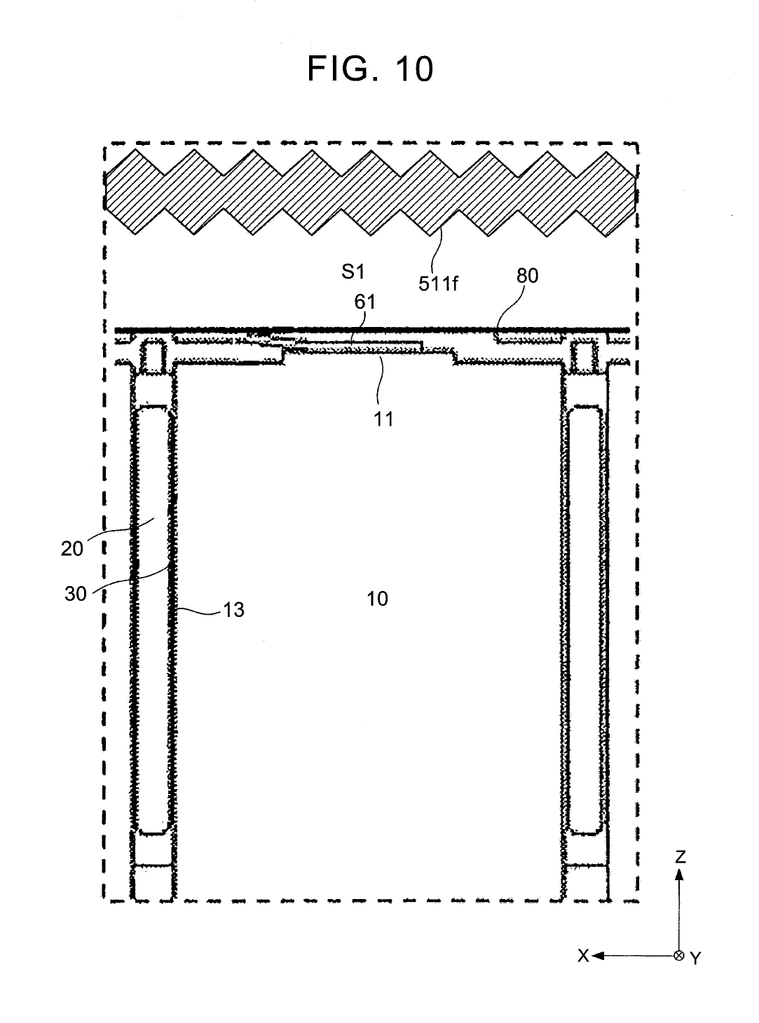

V-shaped portions 511f may be consecutively connected in X-axis direction, as shown in FIG. 10.

Next, explanations are given as to a modified example 2 of the fin shaped portion. In the above embodiment, the positive electrode terminal 11 is formed with the gas exhaustion valve. The gas exhaustion valve may be formed in the negative electrode terminal 12. In such a case, the gas exhaustion path S1 can be formed at a portion adjacent to the negative electrode terminal 12, in which the insulating sheet 80 can be adhered to the busbar 71 welded at the negative electrode terminal 12.

What is claimed is:

1. An assembled battery comprising:
a plurality of single batteries;
a fin shaped portion disposed outside of a plurality of the single batteries, a gas exhaustion path being defined between the fin shaped portion and the plurality of the single batteries, a gas discharged from the single batteries being discharged from the assembled battery to an outside of the assembled battery through the gas exhaustion path in a battery abnormal condition; and
a sheet member disposed between the gas exhaustion path and the plurality of the single batteries, the sheet member being an insulating member.

2. The assembled battery according to claim 1, wherein
the single battery is a tubular single battery, the plurality of the single batteries are disposed in a radius direction of the single battery, the sheet member is kept into contact with a busbar for connecting terminals of the single batteries, and the terminals of the single batteries are adjacent to each other in the radius direction.

3. The assembled battery according to claim 2, wherein
the terminal of the single battery is a positive electrode terminal provided with a gas exhaustion valve.

4. The assembled battery according to claim 3, wherein
the single battery comprises a tubular battery case with a bottom surface serving as a negative electrode terminal, and the positive electrode terminal disposed to close an opening portion of the battery case.

5. The assembled battery according to claim 2, wherein
the terminal of the single battery is a negative electrode terminal provided with a gas exhaustion valve.

6. The assembled battery according to claim 5, wherein
the single battery comprises a tubular battery case with a bottom surface serving as a negative electrode terminal, and the negative electrode terminal disposed to close an opening portion of the battery case.

7. The assembled battery according to claim 1, wherein
the fin shaped portion has a shape providing concave and convex portions consecutively disposed alternately.

8. The assembled battery according to claim 7, wherein
the fin shaped portion is configured to consecutively connect curve shaped portions having curved surfaces.

9. The assembled battery according to claim 8, wherein
the fin shaped portion is configured to consecutively connect the curve shaped portions with a flat shaped portion having a flat surface interposed between the curve shaped portions.

10. The assembled battery according to claim 7, wherein
the fin shaped portion is configured to consecutively connect flat shaped portions to be in concave convex shapes in cross section.

11. The assembled battery according to claim 7, wherein
the fin shaped portion is configured to consecutively connect V-shaped portions.

12. The assembled battery according to claim 7, wherein
each of the concave portions extends in a gas exhaustion direction in the gas exhaustion path.
